(19) United States
(12) Patent Application Publication
(10) Pub. No.: US 2026/0106534 A1
(43) Pub. Date: Apr. 16, 2026

(54) HYBRID RECTIFIERS FOR ALTERNATING CURRENT AND DIRECT CURRENT POWER INPUT TYPES

(71) Applicant: ABB Schweiz AG, Baden (CH)

(72) Inventors: Haiguo Li, Cary, NC (US); Zhou Dong, Chapel Hill, NC (US); Pietro Cairoli, Cary, NC (US); Jing Xu, Cary, NC (US); Dingrui Li, North Charleston, SC (US)

(21) Appl. No.: 18/914,545

(22) Filed: Oct. 14, 2024

(51) Int. Cl. H02M 1/10; H02M 7/217

(52) U.S. Cl. CPC H02M 1/10; H02M 7/217

(57) ABSTRACT

A hybrid rectifier includes first and second DC output terminals, first and second switches, first and second AC/DC input terminals, and circuitry. The first switch is in series with a first diode, the second switch is in series with a second diode, the first AC/DC input terminal is electrically coupled between the first switch and the first diode, and the second AC/DC input terminal is electrically coupled between the second switch and the second diode. The circuitry is configured to determine whether the first and second AC/DC input terminals are supplied DC power or AC power, operate the first and second switches in a conductive state in response to determining that the first and second AC/DC input terminals are supplied DC power, and operate the first and second switches in a nonconductive state in response to determining that the first and second AC/DC input terminals are supplied AC power.

### BACKGROUND

The field of the disclosure relates to rectifiers, and more particularly, to rectifiers for power input types that support both alternating current (AC) and direct current (DC) in the same circuit.

A diode-based rectifier, such as rectifier 100 shown in FIG. 1, is often used to convert an AC power input to a DC power output, which may then be used by other downstream circuits (e.g., a DC-DC converter, DC-AC converter, DC circuits, etc.). Rectifier 100 includes diodes 102, 104, 106, 108, power inputs 110, 112, and power outputs 114, 116. During operation, diodes 102, 104, 106, 108 convert either AC power or DC power provided to power inputs 110, 112 to a DC power output at power outputs 114, 116. When power inputs 114, 116 are supplied by an AC power source, such as a mains AC power, the current flowing through diodes 102, 104, 106, 108 is lower as compared to when power inputs 114, 116 are supplied by a low voltage DC power source for the same power delivery. Due to the higher diode currents when rectifier 100 is supplied by a low voltage DC power source rather than the mains AC power, the voltage drop across diodes 102, 104, 106, 108 results in a larger power loss across diodes 102, 104, 106, 108 as compared to when power inputs 114, 116 are supplied by an AC power source. The result is that rectifier 100 is much less efficient when power inputs 110, 112 are supplied a low voltage DC power supply as compared to an AC power supply.

Thus, it is desirable to improve the operation and performance of rectifiers, and more specifically, improve the operation and performance of rectifiers that convert both AC input power and DC input power to a DC power output.

### BRIEF DESCRIPTION

In one embodiment, a hybrid rectifier is provided. The hybrid rectifier includes first and second DC output terminals, first and second switches, first and second AC/DC input terminals, and circuitry. The first switch is in series with a first diode and forms a first branch, where the first branch is electrically coupled between the first and second DC output terminals. The second switch is in series with a second diode and forms a second branch, where the second branch is electrically coupled between the first and second DC output terminals. The first AC/DC input terminal is electrically coupled between the first switch and the first diode, the first switch is coupled between the first AC/DC input terminal and the first DC output terminal, the second AC/DC input terminal is electrically coupled between the second switch and the second diode, and the second switch is coupled between the second AC/DC input terminal and the second DC output terminal. The circuitry is electrically coupled to the first and second AC/DC input terminals and the first and second switches, and is configured to determine whether the first and second AC/DC input terminals are supplied DC power or AC power, operate the first and second switches in a conductive state in response to determining that the first and second AC/DC input terminals are supplied the DC power, and operate the first and second switches in a nonconductive state in response to determining that the first and second AC/DC input terminals are supplied the AC power.

In another embodiment, a method operable by a controller of a hybrid rectifier is provided. The hybrid rectifier includes first and second DC output terminals, first and second switches, and first and second AC/DC input terminals. The first switch is in series with a first diode and forms a first branch, where the first branch is electrically coupled between the first and second DC output terminals. The second switch is in series with a second diode and forms a second branch, where the second branch is electrically coupled between the first and second DC output terminals. The first AC/DC input terminal is electrically coupled between the first switch and the first diode, the first switch is coupled between the first AC/DC input terminal and the first DC output terminal, the second AC/DC input terminal is electrically coupled between the second switch and the second diode, and the second switch is coupled between the second AC/DC input terminal and the second DC output terminal. The method includes determining whether the first and second AC/DC input terminals are supplied DC power or AC power, operating the first and second switches in a conductive state in response to determining that the first and second AC/DC input terminals are supplied the DC power, and operating the first and second switches in a nonconductive state in response to determining that the first and second AC/DC input terminals are supplied the AC power.

In another embodiment, a hybrid rectifier is provided. The hybrid rectifier includes an H-bridge, DC output terminals, AC/DC input terminals, and circuitry. The H-bridge is formed by first and second switches and first and second diodes, the first switch and first diode forming a first branch, and the second switch and second diode forming a second branch in parallel with the first branch. The DC output terminals are coupled at opposing ends of the first and second branches. The AC/DC input terminals are coupled between the opposing ends of the first and second branches. The circuitry is electrically coupled to the AC/DC input terminals and the first and second switches, and is configured to determine whether the AC/DC input terminals are supplied DC power or AC power, operate the first and second switches in a conductive state in response to determining that the AC/DC input terminals are supplied the DC power, and operate the first and second switches in a nonconductive state in response to determining that the AC/DC input terminals are supplied the AC power.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1 depicts a known diode-based rectifier.

FIG. 2 depicts a hybrid rectifier in an exemplary embodiment.

FIG. 3 depicts a hybrid rectifier that utilizes a voltage type detector as a front-end along with and a control circuit as a control scheme in another exemplary embodiment.

FIG. 4 depicts a hybrid rectifier that utilizes a low-pass filter front-end along with a multivibrator control scheme in an exemplary embodiment.

FIG. 5 depicts a hybrid rectifier that utilizes a low-pass filter front-end along with a multivibrator control scheme in another exemplary embodiment.

FIG. 6 depicts a hybrid rectifier that utilizes relays in an exemplary embodiment.

FIG. 7 depicts simulation waveforms for the circuits depicted in FIGS. 4-6 in an exemplary embodiment.

FIG. 8 is a flow chart of a method operable by a controller of a hybrid rectifier in an exemplary embodiment.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc - read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

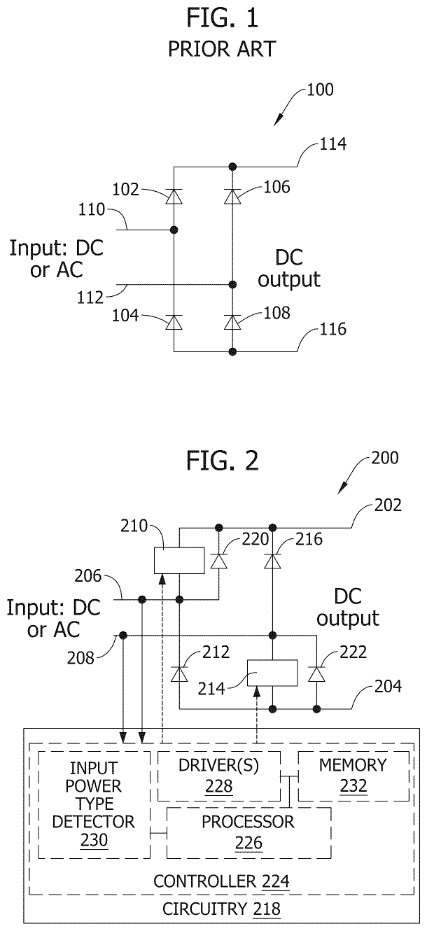

For an isolated AC/DC power supply, a diode-based front-end rectifier 100, as shown in FIG. 1, is often used to covert the AC power input to DC power output, and then a downstream isolated DC/DC converter is used to realize the isolation and voltage conversion. For AC and DC compatible power input applications, the front-end rectifier (e.g., rectifier 100) is also needed. However, as discussed briefly above, when the DC input voltage is low, for the same output power, the input current is large, which results in a large power loss in diodes 102, 104, 106, 108. Using a larger diode may not reduce the loss by much, because the voltage drop of the barrier potential of the p-n junction is almost constant (usually 0.6 volts to 0.7 volts for a silicon-based diode). Although Schottky diodes have a lower voltage drop, they typically have a low voltage rating and multiple diodes in series must be used to withstand the high voltages when rectifier 100 is supplied with an AC input, which still results in a large power loss when the input is a low voltage DC input. Higher voltage Schottky diodes (e.g., greater than 600 volts) are available, but their voltage drops are also comparable to silicon-based diodes with the same voltage rating. Further, the cost of high voltage Schottky diodes is higher than their corresponding silicon-based diodes.

FIG. 2 depicts a hybrid rectifier 200 in an exemplary embodiment. In this embodiment, hybrid rectifier 200 includes first and second DC output terminals 202, 204, and first and second AC/DC input terminals 206, 208. First and second AC/DC input terminals 206, 208 may be supplied by an AC power source or a DC power source. First and second DC output terminals 202, 204 provide DC output power to downstream circuits (not shown), such as DC-DC converters, DC-AC converters, DC circuits, etc.

In this embodiment, hybrid rectifier 200 further includes a first switch 210 in series with a first diode 212 that forms a first branch, and a second switch 214 in series with a second diode 216 that forms a second branch. In this embodiment, both the first and second branches are electrically coupled between the first and second DC output terminals 202, 204. In some embodiments, first switch 210 in series with first diode 212 that forms the first branch, and second switch 214 in series with second diode 216 that forms the second branch may be collectively referred to as an H-bridge.

In some embodiments, first and/or second switches 210, 214 include one or more solid-state switches. Some examples of solid-state switches include Insulated-Gate Bipolar Transistors, Reverse Blocking-Integrated Gate Commutated Thyristors, Silicon-Carbide Metal-Oxide-Semiconductor Field-Effect Transistors, Silicon Metal-Oxide-Semiconductor Field-Effect Transistors (MOSFETs), and Gallium Nitride Field-Effect Transistors, etc.

In addition to or instead of, in some embodiments, first and/or second switches 210, 214 include relays, mechanical switches, contactors, etc.

In this embodiment, first AC/DC input terminal 206 is electrically coupled between first switch 210 and first diode 212, and second AC/DC input terminal 208 is electrically coupled between second switch 214 and second diode 216. First switch 210 is electrically coupled between first AC/DC input terminal 206 and first DC output terminal 202, and second switch 214 is electrically coupled between second DC output terminal 204 and second AC/DC input terminal 208.

In this embodiment, hybrid rectifier 200 further includes circuitry 218, which controls the operation of hybrid rectifier 200. Circuitry 218 is electrically coupled to first and second AC/DC input terminals and first and second switches 210, 214. During operation, circuitry 218 determines whether first and second AC/DC input terminals 206, 208 are supplied DC power or AC power, and varies the operation of first and second switches 210, 214 based on whether the power input to hybrid rectifier 200 is AC power or DC power. In particular, circuitry 218 operates first and second switches 210, 214 in a conductive state in response to determining that first and second AC/DC input terminals 206, 208 are supplied DC power, and operates first and second switches 210, 214 in a nonconductive state in response to determining that first and second AC/DC input terminals 206, 208 are supplied AC power.

When the power supplied to hybrid rectifier 200 is DC power, first and second switches 210, 214 are operated by circuitry 218 in a conductive state, and first and second switches 210, 214 will have a lower voltage drop than diodes 102, 108 of FIG. 1. The result is that the power loss when hybrid rectifier 200 is provided DC power (especially low voltage DC power) is less than rectifier 100, and consequentially, hybrid rectifier 200 is more efficient than rectifier 100 of FIG. 1.

When the power supplied to hybrid rectifier 200 is AC power, first and second switches 210, 214 are operated by circuitry 218 in a nonconductive state. In a first half cycle of the input AC power waveform, current will flow through the body diodes of first and second switches 210, 214 (if present) or will flow through a third diode 220 that is in parallel with first switch 210 and a fourth diode 222 that is in parallel with second switch 214. Third and fourth diodes 220, 222 may be used in hybrid rectifier 200 when first and second switches 210, 214 do not include body diodes, for example, when first and/or second switches 210, 214 are relays, mechanical switches, contactors, or solid-state devices that do not include body diodes. In some embodiments, third and fourth diodes 220, 222 may be used even if first and second switches 210, 214 include body diodes, depending on the expected current that would flow through the body diodes.

In a second half cycle of the input AC power waveform, current will flow through first and second diodes 212, 216. Therefore in the AC power input case, the current path through hybrid rectifier 200 is similar to the current path through rectifier 100 of FIG. 1.

Generally, circuitry 218 comprises any component, system, or device which performs the functions described herein for circuitry 218. In one embodiment, circuitry 218 includes a controller 224. Controller 224 includes at least one processor 226, at least one driver 228, an input power type detector 230, and a memory 232. Driver 228 is electrically coupled to first and second switches 210, 214 and operates to modify the operation of first and second switches 210, 214 between the conductive and nonconductive states. Driver 228 may include one or more gate drivers, relay drivers, mechanical switch drivers, contactor drivers, etc., which are used to modify the operation of first and second switches 210, 214 between the conductive state and the nonconductive state.

Input power type detector 230 is electrically coupled to first and second AC/DC input terminals 206, 208, and operates to sense whether first and second AC/DC input terminals 206, 208 are supplied DC power or AC power. Input power type detector 230 may include various analog and/or digital circuits that are used to determine the type of power supplied to hybrid rectifier 200, including voltage dividers, low-pass filters, comparators, analog-to-digital converters, etc.

In some embodiments, memory 232 may store programmed instructions for processor 226. During operation, processor 226 executes the programmed instructions to implement the functionality previously described for circuitry 218. In particular, the programmed instructions cause processor 226 to determine, utilizing input power type detector 230, whether first and second AC/DC input terminals 206, 208 are supplied DC power or AC power, and vary, utilizing driver(s) 228, the operation of first and second switches 210, 214 between the conductive state and the nonconductive state based on whether the power input to hybrid rectifier 200 is AC power or DC power.

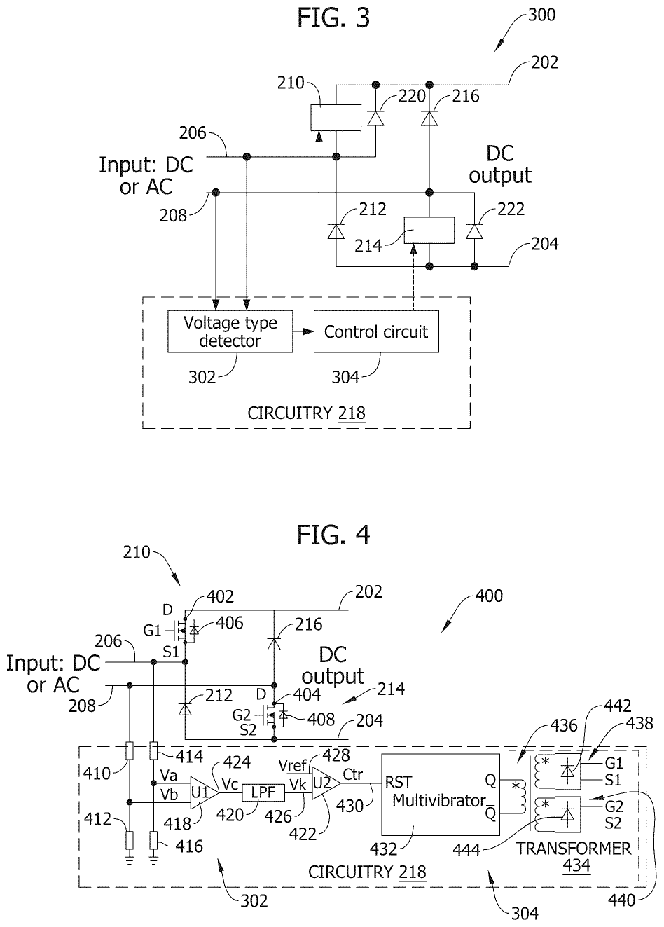

FIG. 3 depicts hybrid rectifier 300 that utilizes a voltage type detector 302 as a front-end along with and a control circuit 304 as a control scheme in another exemplary embodiment.

In this embodiment, voltage type detector 302 is electrically coupled to first and second AC/DC input terminals 206, 208, and operates to sense whether first and second AC/DC input terminals 206, 208 are supplied DC power or AC power. Voltage type detector 302 may include various analog and/or digital circuits that are used to determine the type of power supplied to hybrid rectifier 300, including voltage dividers, low-pass filters, comparators, analog-to-digital converters, etc., and may operate similarly as previously described for input power type detector 230 of FIG. 2.

Control circuit 304 is electrically coupled to voltage type detector 302 and first and second switches 210, 214. During operation, control circuit 304 implements the functionality previously described for circuitry 218. In particular, control circuit 304 determines, utilizing voltage type detector 302, whether first and second AC/DC input terminals 206, 208 are supplied DC power or AC power, and varies the operation of first and second switches 210, 214 between the conductive state and the nonconductive state based on whether the power input to hybrid rectifier 300 is AC power or DC power.

FIG. 4 depicts a hybrid rectifier 400 that utilizes a low-pass filter front-end along with a multivibrator control scheme in an exemplary embodiment. In this embodiment, first and second switches 210, 214 have been replaced with first and second solid-state switches 402, 404 (e.g., MOSFETs in this embodiment), respectively, which operate similarly as described for first and second switches 210, 214. First and second solid-state switches 402, 404 include first and second body diodes 406, 408, respectively, which also operate similarly as described for third and fourth diodes 220, 222 as previously described with respect to FIG. 2.

In this embodiment, first and second sold-state switches 402, 404 each include a gate (G), source(S), and drain (D) electrically connected as shown in FIG. 4 to first and second AC/DC input terminals 206, 208 and first and second DC output terminals 202, 204. Accordingly, first and second diodes 212, 216 each include a cathode and an anode electrically connected as shown in FIG. 4 to first and second AC/DC input terminals 206, 208 and first and second DC output terminals 202, 204.

In this embodiment, voltage type detector 302 is formed from a plurality of voltage dividing resistors 410, 412, 414, 416, a first comparator 418, a low-pass filter 420, and a second comparator 422. In some embodiments, first and second comparators 418, 420 may comprise operational amplifiers.

First comparator 418 is electrically coupled to first and second AC/DC input terminals 206, 208 via voltage dividing resistors 410, 412, 414, 416, and low-pass filter 420 is coupled to an output 424 of first comparator 418. Second comparator 422 is electrically coupled to an output 426 of low-pass filter 420, and compares output 426 with a reference voltage 428 to generate, based on the comparison, a control signal 430. Generally, first comparator 418 is used to compare the voltages at first and second AC/DC input terminals 206, 208, and output 424 of first comparator 418 is either high or low. When DC power is supplied to first and second AC/DC input terminals 206, 208, output 424 of first comparator 418 is always either high or low. In this embodiment, Va is connected to the positive input terminal of comparator 418 and Vb is connected to the negative input terminal of comparator 418. Therefore, the output Vc of comparator 418 is always high for a DC power input. When AC power is supplied to first and second AC/DC input terminals 206, 208, output 424 of first comparator 418 is high or low each half AC cycle, and reverses in the other half AC cycle. Low-pass filter 420 filters output 424 of first comparator 418 such that output 426 of low-pass filter is doubled in the DC input power case as compared to the AC input power case. Second comparator 422 compares output 426 with the reference voltage 428 to generate, based on the comparison, control signal 430 that has a different value depending on whether the input power supplied is AC power or DC power.

In this embodiment, control circuit 304 is formed from a multivibrator 432 and a transformer 434. Multivibrator 432 has an input coupled to control signal 430 (e.g., the RST pin of a CD4047), and a pair of complimentary outputs (Q and Q̅) that generate an oscillating output. During operation, control signal 430 is high when AC power is supplied to hybrid rectifier 400, multivibrator 432 does not generate an oscillating output at (Q and Q̅), and first and second solid-state switches 402, 404 are in the nonconductive state.

Control signal 430 is low when DC power is supplied to hybrid rectifier 400, and multivibrator 432 generates an oscillating output at (Q and Q̅) which is coupled to first and second solid-state switches 402, 404 via transformer 434. In particular, the output of multivibrator 432 (Q and Q̅) is coupled to a primary winding 436 of transformer 434, and first and second solid-state switches 402, 404 are coupled to secondary windings 438, 440, respectively, of transformer 434. In this embodiment, secondary windings 438, 440 are each coupled to rectifiers 442, 444, respectively. The output of first rectifier 442 is coupled across the gate (G1) and the source (S1) of first solid-state switch 402, and the output of second rectifier 444 is coupled across the gate (G2) and the source (S2) of second solid-state switch 404.

When multivibrator 432 generates an oscillating output at (Q and Q̅), first and second solid-state switches 402, 404 are in the conductive state via the operation of transformer 434 and rectifiers 442, 444. Transformer 434 therefore provides an isolated gate drive signal to first and second sold-state switches 402, 404.

When the power supplied to hybrid rectifier 400 is DC power, with first and second solid-state switches 402, 404 in the conductive state, and first and second solid-state switches 402, 404 will have a lower voltage drop than diodes 102, 108 of FIG. 1. The result is that the power loss when hybrid rectifier 400 is provided DC power (especially low voltage DC power) is less than rectifier 100, and consequentially, hybrid rectifier 400 is more efficient than rectifier 100 of FIG. 1.

When AC power is supplied to hybrid rectifier 400, in a first half cycle of the input AC power waveform, current will flow through first and second body diodes 406, 408 of first and second solid-state switches 402, 404, respectively. In a second half cycle of the input AC power waveform, current will flow through first and second diodes 212, 216. Therefore in the AC power input case, the current path through hybrid rectifier 400 is similar to the current path through rectifier 100 of FIG. 1.

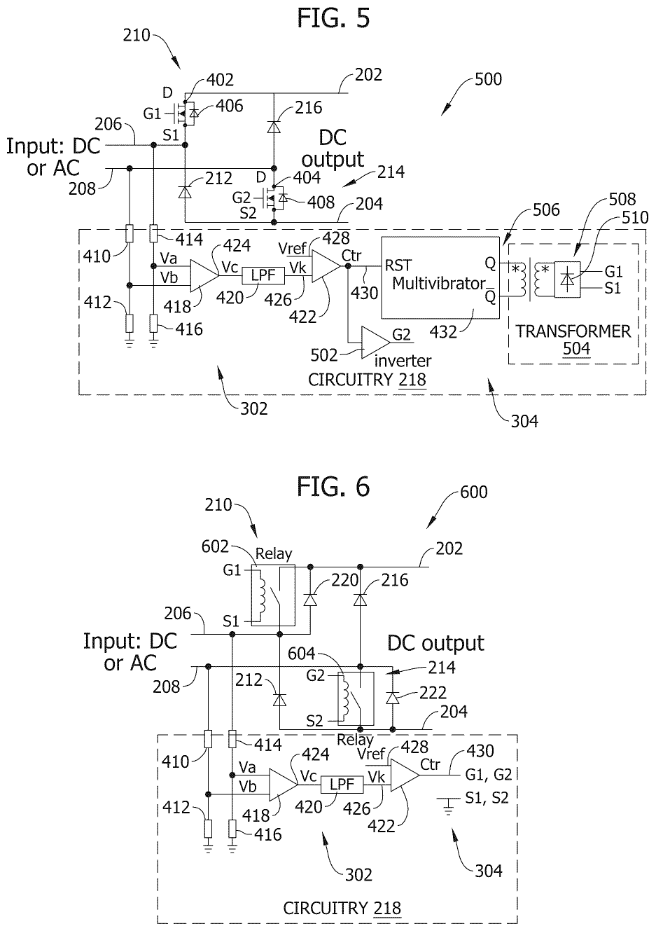

FIG. 5 depicts a hybrid rectifier 500 that utilizes a low-pass filter front-end along with a multivibrator control scheme in another exemplary embodiment. Hybrid rectifier 500 is similar to hybrid rectifier 400 of FIG. 4, with the addition of an inverter 502 electrically coupled to control signal 430 and the use of transformer 504, which is similar to transformer 434 with one primary winding 504 and one secondary winding 506 coupled to a rectifier 510. During operation, control signal 430 is high when AC power is supplied to hybrid rectifier 500, multivibrator 432 does not generate an oscillating output at (Q and Q̅), and first and second solid-state switches 402, 404 are in the nonconductive state. Control signal 430 is low when DC power is supplied to hybrid rectifier 500, and multivibrator 432 generates oscillating output at (Q and Q̅), which is coupled to first solid-state switch 402 via transformer 504. In particular, the output of multivibrator 432 (Q and Q̅) is coupled to a primary winding 506 of transformer 504, and first solid-state switch 402 is coupled to a secondary winding 508 of transformer 504 via rectifier 510.

In this embodiment, the output of rectifier 510 is coupled across the gate (G1) and the source (S1) of first solid-state switch 402. When multivibrator 432 generates an oscillating output at (Q and Q̅), first solid-state switch 402 is in the conductive state. The output of inverter 502 directly drives the gate (G2) of second solid-state switch 404 based on an inverted version of control signal 430 such that both first and second solid-state switches 402, 404 are in the conductive state when DC power is supplied to hybrid rectifier 500. Correspondingly, both first and second solid-state switches 402, 404 are in the nonconductive state when AC power is supplied to hybrid rectifier 500. Transformer 504 therefore provides an isolated gate drive signal to only first a sold-state switch 402 in this embodiment.

FIG. 6 depicts a hybrid rectifier 600 that utilizes relays 602, 604 in an exemplary embodiment. In this embodiment, first and second switches 210, 214 have been replaced with first and second relays 602, 604, respectively, which operate similarly as described for first and second switches 210, 214. In this embodiment, control signal 430 is coupled to relays 602, 604, and operates to energize or de-energize the coils of first and second relays 602, 604.

When the power supplied to hybrid rectifier 600 is DC power, control signal 430 operates to close the mechanical contacts of relays 602, 604, which operates first and second relays 602, 604 in the conductive state. First and second relays 602, 604 will have a lower voltage drop than diodes 102, 108 of FIG. 1. The result is that the power loss when hybrid rectifier 600 is provided DC power (especially low voltage DC power) is less than rectifier 100, and consequentially, hybrid rectifier 600 is more efficient than rectifier 100 of FIG. 1.

When the power supplied to hybrid rectifier 600 is AC power, control signal 430 operates to open the mechanical contacts of relays 602, 604, which operates first and second relays 602, 604 in the nonconductive state. In a first half cycle of the input AC power waveform, current will flow through the third diode 220 that is in parallel with first relay 602 and fourth diode 222 that is in parallel with second relay 604. In a second half cycle of the input AC power waveform, current will flow through first and second diodes 212, 216. Therefore in the AC power input case, the current path through hybrid rectifier 600 is similar to the current path through rectifier 100 of FIG. 1.

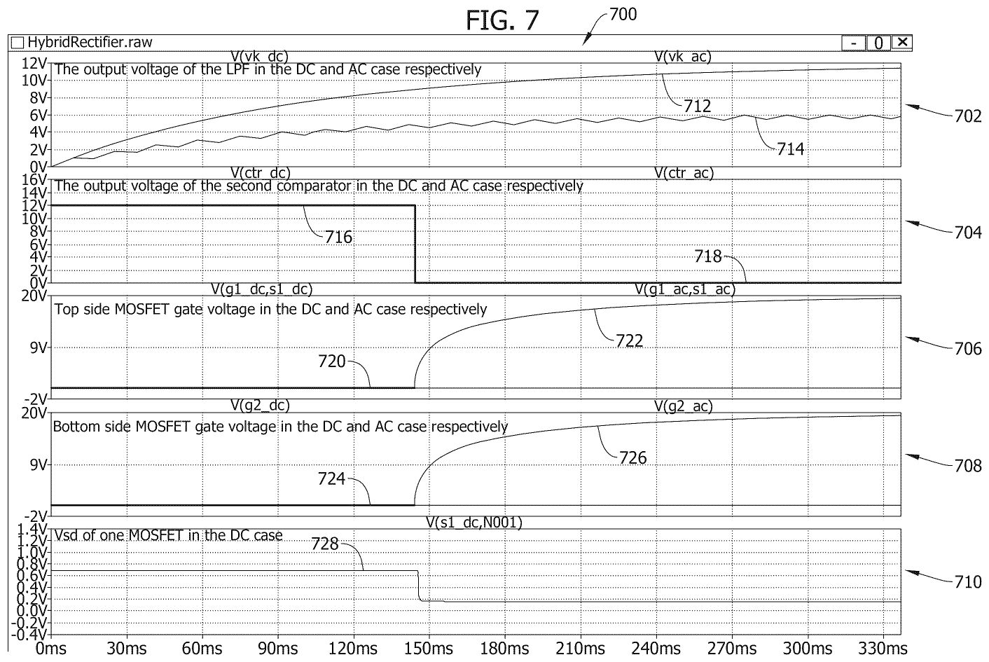

FIG. 7 depicts simulation waveforms 700 for the circuits depicted in FIGS. 4 and 5 in an exemplary embodiment. Waveforms 702 depicts a voltage 712 of output 426 of low-pass filter 420 when DC power is supplied to hybrid rectifiers 400, 500, and a voltage 714 of output 426 of low-pass filter 420 when AC power is supplied to hybrid rectifiers 400, 500.

Waveforms 704 depicts a voltage 716 of control signal 430 of second comparator 422 when DC power is supplied to hybrid rectifiers 400, 500, and a voltage 718 of control signal 430 of second op-amp 422 when AC power is supplied to hybrid rectifiers 400, 500.

Waveforms 706 depicts a gate voltage 720 of first solid-state switch 402 when DC power is supplied to hybrid rectifiers 400, 500, and a gate voltage 722 of first solid-state switch 402 when AC power is supplied to hybrid rectifiers 400, 500.

Waveforms 708 depicts a gate voltage 724 of second solid-state switch 404 when DC power is supplied to hybrid rectifiers 400, 500, and a gate voltage 726 of second solid-state switch 404 when AC power is supplied to hybrid rectifiers 400, 500.

Waveform 710 depicts a source to drain voltage 728 of either first or second solid-state switches 402, 404 when DC power is supplied to hybrid rectifiers 400, 500.

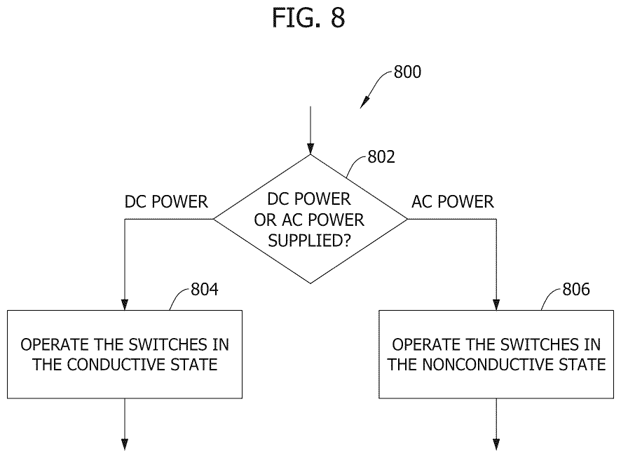

FIG. 8 depicts a flow chart of a method 800 operable by a controller of a hybrid rectifier in an exemplary embodiment. Method 800 will be discussed with respect to hybrid rectifiers 200, 300, 400, 500, 600, although method 800 may be performed by other hybrid rectifiers, not shown.

Method 800 comprises determining 802 whether DC power or AC power is being supplied to the hybrid circuit breaker. For example, circuitry 218 of hybrid rectifiers 200, 300, 400, 500, 600 determines whether DC power or AC power is being supplied to first and second AC/DC input terminals 206, 208, as previously described. If hybrid rectifiers 200, 300, 400, 500, 600 are being supplied by DC power, then circuitry 218 operates 804 first and second switches 210, 214 in the conductive state as previously described with respect to FIGS. 2-6. If hybrid rectifiers 200, 300, 400, 500, 600 are being supplied by AC power, then circuitry 218 operates 806 first and second switches 210, 214 in the nonconductive state as previously described with respect to FIGS. 2-6.

An example technical effect of the apparatus and method described herein includes, at least, improving the performance of diode rectifiers that are provided both AC and DC input power and in particular, to providing high efficiency operation for high voltage AC input and low voltage DC input scenarios.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A hybrid rectifier, comprising:
first and second direct current (DC) output terminals;
a first switch in series with a first diode forming a first branch, wherein the first branch is electrically coupled between the first and second DC output terminals;
a second switch in series with a second diode forming a second branch, wherein the second branch is electrically coupled between the first and second DC output terminals;
first and second alternating current/direct current (AC/DC) input terminals, wherein the first AC/DC input terminal is electrically coupled between the first switch and the first diode, wherein the first switch is coupled between the first AC/DC input terminal and the first DC output terminal, wherein the second AC/DC input terminal is electrically coupled between the second switch and the second diode, and wherein the second switch is coupled between the second AC/DC input terminal and the second DC output terminal; and
circuitry electrically coupled to the first and second AC/DC input terminals and the first and second switches, the circuitry configured to:
determine whether the first and second AC/DC input terminals are supplied DC power or AC power;
operate the first and second switches in a conductive state in response to determining that the first and second AC/DC input terminals are supplied the DC power; and
operate the first and second switches in a nonconductive state in response to determining that the first and second AC/DC input terminals are supplied the AC power.

2. The hybrid rectifier of claim 1, further comprising:
a third diode electrically coupled in parallel with the first switch; and
a fourth diode electrically coupled in parallel with the second switch.

3. The hybrid rectifier of claim 2, wherein:
the first and second switches comprise first and second solid-state switches, and
the third and fourth diodes comprise body diodes of the first and second solid-state switches, respectively.

4. The hybrid rectifier of claim 1, wherein:
the first and second switches comprise solid-state switches.

5. The hybrid rectifier of claim 4, wherein:
the solid-state switches comprise one or more of Insulated-Gate Bipolar Transistors, Reverse Blocking-Integrated Gate Commutated Thyristors, Silicon-Carbide Metal-Oxide-Semiconductor Field-Effect Transistors, Silicon Metal-Oxide-Semiconductor Field-Effect Transistors, and Gallium Nitride Field-Effect Transistors.

6. The hybrid rectifier of claim 1, wherein:
the first and second switches comprise relays.

7. The hybrid rectifier of claim 1, wherein:
the first and second switches comprise contactors.

8. The hybrid rectifier of claim 1, wherein:
the first and second switches comprise mechanical switches.

9. The hybrid rectifier of claim 1, wherein the circuitry comprises a controller, and wherein the controller comprises:
at least one processor;
at least one driver electrically coupled to the first and second switches and configured to modify the operation of the first and second switches;
an input power type detector electrically coupled to the first and second AC/DC input terminals and configured to sense whether the first and second AC/DC input terminals are supplied the DC power or the AC power; and
a memory configured to store programmed instructions which, when executed by the at least one processor, causes the at least one processor to:
determine, utilizing the input power type detector, whether the first and second AC/DC input terminals are supplied the DC power or the AC power;
operate, utilizing the at least one driver, the first and second switches in the conductive state in response to determining that the first and second AC/DC input terminals are supplied the DC power; and
operate, utilizing the at least one driver, the first and second switches in the nonconductive state in response to determining that the first and second AC/DC input terminals are supplied the AC power.

10. The hybrid rectifier of claim 1, wherein the circuitry comprises:
a voltage type detector electrically coupled to the first and second AC/DC input terminals and configured to sense whether the first and second AC/DC input terminals are supplied the DC power or the AC power; and
a control circuit electrically coupled to the voltage type detector and the first and second switches, the control circuit configured to:
determine, utilizing the voltage type detector, whether the first and second AC/DC input terminals are supplied the DC power or the AC power;
operate the first and second switches in the conductive state in response to determining that the first and second AC/DC input terminals are supplied the DC power; and
operate the first and second switches in the nonconductive state in response to determining that the first and second AC/DC input terminals are supplied the AC power.

11. The hybrid rectifier of claim 10, wherein the voltage type detector comprises:
a first comparator electrically coupled to the first and second AC/DC input terminals via a plurality of voltage scaling resistors;
a low-pass filter (LPF) electrically coupled to an output of the first comparator;
a second comparator configured to compare an output of the LPF a with a reference voltage and generate, based on the comparison, a control signal for the control circuit.

12. The hybrid rectifier of claim 11, wherein the control circuit comprises:
a multivibrator having an input coupled to the control signal and a pair of complimentary outputs; and
a transformer comprising:
a primary winding coupled to the pair of complimentary outputs;
a first secondary winding coupled, via a first rectifier, to the first switch; and
a second secondary winding coupled, via a second rectifier, to the second switch.

13. The hybrid rectifier of claim 11, wherein the control circuit comprises:
a multivibrator having an input coupled to the control signal and a pair of complimentary outputs;
a transformer comprising:
a primary winding coupled to the pair of complimentary outputs; and
a secondary winding coupled, via a rectifier, to the first switch; and
an inverter having an input coupled to the control signal and an output coupled to the second switch.

14. The hybrid rectifier of claim 11, wherein:
the first and second switches comprise first and second relays, and
the control signal is electrically coupled to coils of the first and second relays and is configured to modify the first and second relays between the conductive state and the nonconductive state.

15. A method operable by a controller of a hybrid rectifier, wherein:
the hybrid rectifier comprises:
first and second direct current (DC) output terminals;
a first switch in series with a first diode forming a first branch, wherein the first branch is electrically coupled between the first and second DC output terminals;
a second switch in series with a second diode forming a second branch, wherein the second branch is electrically coupled between the first and second DC output terminals; and
first and second alternating current/direct current (AC/DC) input terminals, wherein the first AC/DC input terminal is electrically coupled between the first switch and the first diode, wherein the first switch is coupled between the first AC/DC input terminal and the first DC output terminal, wherein the second AC/DC input terminal is electrically coupled between the second switch and the second diode, and wherein the second switch is coupled between the second AC/DC input terminal and the second DC output terminal, and
the method comprises:
determining whether the first and second AC/DC input terminals are supplied DC power or AC power;
operating the first and second switches in a conductive state in response to determining that the first and second AC/DC input terminals are supplied the DC power; and
operating the first and second switches in a nonconductive state in response to determining that the first and second AC/DC input terminals are supplied the AC power.

16. A hybrid rectifier, comprising:
an H-bridge formed by first and second switches and first and second diodes, the first switch and first diode forming a first branch, and the second switch and second diode forming a second branch in parallel with the first branch;
direct current (DC) output terminals coupled at opposing ends of the first and second branches;
alternating current/direct current (AC/DC) input terminals coupled between the opposing ends of the first and second branches; and
circuitry electrically coupled to the AC/DC input terminals and the first and second switches, the circuitry configured to:
determine whether the AC/DC input terminals are supplied DC power or AC power;
operate the first and second switches in a conductive state in response to determining that the AC/DC input terminals are supplied the DC power; and
operate the first and second switches in a nonconductive state in response to determining that the AC/DC input terminals are supplied the AC power.

17. The hybrid rectifier of claim 16, wherein:
the first switch has a first drain electrically coupled to a first DC output terminal of the DC output terminals, a first gate, and a first source electrically coupled to a first AC/DC input terminal of the AC/DC input terminals;
the first diode has a first cathode electrically coupled to the first AC/DC input terminal, and a first anode electrically coupled to a second DC output terminal of the DC output terminals;
the second switch has a second drain electrically coupled to a second AC/DC input terminal of the AC/DC input terminals, a second gate, and a second source electrically coupled to the second DC output terminal;
the second diode has a second cathode electrically coupled to the first DC output terminal and a second anode electrically coupled to the second AC/DC input terminal,
wherein the control circuit is configured to apply a gate drive signal to the first and second gates to operate the first and second switches between the conductive and nonconductive states.

18. The hybrid rectifier of claim 17, wherein:
the first and second switches comprise solid-state devices having first and second body diodes, and
the first and second body diodes alternate in conducting current with the first and second diodes while the first and second switches are in the nonconductive state and the first and second AC/DC input terminals are supplied by the AC power.

19. The hybrid rectifier of claim 18, wherein the circuitry comprises a controller, and wherein the controller comprises:
at least one processor;
at least one driver electrically coupled to the first and second switches and configured to modify the operation of the first and second switches;
an input power type detector electrically coupled to the first and second AC/DC input terminals and configured to sense whether the first and second AC/DC input terminals are supplied the DC power or the AC power; and
a memory configured to store programmed instructions which, when executed by the at least one processor, cause the at least one processor to:
determine, utilizing the input power type detector, whether the first and second AC/DC input terminals are supplied the DC power or the AC power;
operate, utilizing the at least one driver, the first and second switches in the conductive state in response to determining that the first and second AC/DC input terminals are supplied the DC power; and
operate, utilizing the at least one driver, the first and second switches in the nonconductive state in response to determining that the first and second AC/DC input terminals are supplied the AC power.

20. The hybrid rectifier of claim 16, wherein the first and second switches comprise one or more of:
relays;
contactors; and
mechanical switches.
